(19) United States
(12) Patent Application Publication
(10) Pub. No.: US 2024/0116733 A1
(43) Pub. Date: Apr. 11, 2024

(54) Apparatus for Feeding through Strands

(71) Applicant: ICOTEK PROJECT GMBH & CO. KG, Eschach (DE)

(72) Inventors: Bruno Ehmann, Schwäbisch Gmünd (DE); Valentin Ehmann, Mögglingen (DE)

(21) Appl. No.: 18/276,235

(22) PCT Filed: Feb. 7, 2022
(86) PCT No.: PCT/EP22/52809

§ 371 Date: Aug. 7, 2023

(30) Foreign Application Priority Data
Feb. 11, 2021 (DE) 102021201300.7

(51) Int. Cl. B65H 57/02; B65H 57/06

(52) U.S. Cl. CPC B65H 57/02; B65H 57/06; B65H 57/26

(57) ABSTRACT

The invention relates to an apparatus for feeding elongated strands through an aperture in a plate having a divided frame, which comprises a frame bottom part and a frame cover which are divided transversely to the running direction of the elongated strands to be inserted, and which has at least one chamber for the insertion of at least one elastic grommet, wherein the frame has devices for fastening the frame to the plate. The apparatus according to the invention is characterized in that the devices comprise hooks for fastening the frame in the aperture of the plate or in fastening holes in the plate, wherein at least two hooks are provided which are designed to be movable relative to one another, wherein at least one of the hooks is designed as part of or movable indirectly by a link element which is movable relative to the frame via a fastening element transversely to the running direction of the accommodated elongated strands.

The invention relates to an apparatus for feeding elongated strands, such as cables, hoses or the like, through an aperture in a plate, for example the wall of a control cabinet or the like, according to the type defined in more detail in the preamble of claim 1.

Apparatuses of this type are known in principle, for example, from EP 1 236 256 B1 or, in a further development thereof, from EP 2 323 236 A2. In these generic designs, the apparatus itself comprises a divided frame, which comprises a substantially U-shaped lower frame part and a frame cover. Substantially U-shaped here refers to the fact that this U, which is formed by a base and two outer legs, frequently still has intermediate webs which are connected or can be connected to the base parallel to the two legs of the U in the interior of the U. In this regard, the frame cover may have substantially the same shape as the lower frame part, as is the case, for example, in the aforementioned specifications. Alternatively, frame covers are also conceivable which close the U as a substantially flat cover. In this connection, reference can be made by way of example to EP 2 746 634 A1, wherein, in addition to this variant which can be connected by clips or snaps, flat covers are also known from the prior art which are screwed to the lower frame part in a manner comparable to the substantially U-shaped covers of the above-mentioned specifications. Two essentially L-shaped frame parts are also known from the prior art, in which case both frame parts can preferably but not necessarily be designed as identical parts.

Elastic grommets are then inserted into the chambers of the frame, which typically have one or more holes for accommodating cables. These elastic grommets are often of slotted design, so that the opening in the elastic grommet provided for accommodating the cable, hose or the like is connected via a slot to one of the side edges, so that preassembled cables with connectors already fitted, hoses with hose couplings already fitted and the like can also be inserted into the grommets that can be opened for this purpose. Due to the elasticity of the grommet, it can then be appropriately closed around the elongated strand and pushed into the chamber, in which it is typically positively and sealingly seated and, when the cover is fitted, sealingly pressed both against the walls of the chamber or frame and against the elongated strand. This ensures a very good seal and at the same time strain relief of the strand.

In practice, it is now typically the case that this structure of the apparatus is pre-assembled with the frame, the grommets and the inserted elongated strands. If required, dummy grommets, as grommets without an opening, can also be inserted in order to cover a wide range of applications with as few frame sizes as possible. In this context, the chambers can accommodate grommets of different sizes, for example, in order to be able to feed one cable or a plurality of cables or strands through one grommet or the like. All of this arises essentially from the aforementioned prior art. The lower frame part and the frame cover are then bolted together, or in the case of the latter prior art, clipped together. This assembly is then mounted to a plate or wall of a control cabinet via screws, typically with a gasket placed in between. The frame then sits in a sealing manner around an opening in the plate, thus ensuring a sealed and strain-relieved introduction of the elongated strands into an installation space enclosed by the plate, for example the control cabinet already mentioned several times. The plate is typically made of a correspondingly thin material, for example a metal sheet. For fastening by means of the screws shown and common in the prior art, a nut must therefore be provided on the opposite side of the plate, i.e. the side facing away from the assembled frame, optionally with appropriate washers, which makes the assembly of the frame relatively complex. Moreover, due to the connection of the cover by means of the screw connection perpendicular to the running direction of the elongated strands, it is necessary to completely disassemble the frame in order to be able to open the cover in case one or more of the elongated strands need to be replaced. Thus, all of the typically 6 to 8 screws must be loosened. Depending on the ambient conditions and intended use, this may optionally be very time-consuming.

It is now the object of the present invention to provide an improved apparatus according to the preamble of claim 1, which in particular avoids the disadvantages mentioned.

According to the invention, this object is solved by an apparatus having the features in claim 1, and here in particular in the characterizing part of claim 1. Advantageous designs and further developments of the apparatus according to the invention result from the subclaims dependent thereon.

In the apparatus according to the invention, the devices for fastening the frame to the plate in the region of the frame, e.g. in the case of a substantially U-shaped lower frame part in the region of the two outer legs, are now no longer designed as holes for receiving screws. Rather, according to the invention, these are designed with hooks for fastening the frame in the aperture of the plate or in fastening holes in the plate. At least one of the hooks is part of a link element or is moved indirectly by such an element, which can be moved transversely to the running direction of the accommodated elongated strands relative to the frame via at least one fastening element.

One or preferably two link elements are thus formed in the frame and cooperate with one or preferably also two further hooks in that the hooks move relative to one another. Via the fastening element, the at least one link element with the hook can be moved transversely to the running direction of the accommodated strands. The hook connected to the link element can thus be moved via this one fastening element per link element, typically two fastening elements in the case of a typical frame size. It can move towards or away from at least one fixed hook in the plane transverse to the running direction of the accommodated elongated strands, depending on the type of actuation of the fastening element, i.e. a loosening or fastening. This allows the frame to be fixed in the aperture of the plate by bracing the hooks with the plate without the need for accessibility from the opposite side of the plate, as is typically the case in the prior art.

Transverse to the running direction of the accommodated elongated strands can mean on the one hand parallel to the plate. i.e. at an angle of approximately 90° to the running direction of the accommodated elongated strands, or can also be oblique thereto, i.e. for example at 600 to the running direction of the accommodated elongated strands, as long as always at least one component of this transverse direction has a movement component along the plate. The link element can thus be moved directly along the plate or more or less obliquely away from or towards it along the plate.

The other hooks can also be movable or preferably stationary. Both movement in the transverse direction and—alternatively or additionally—movement parallel to the running direction of the inserted strands are conceivable, for example in order to influence the height of the hooks above the frame or to be able to loosen or retighten them from the front of the frame as required via a further screw. This makes it possible to compensate for tolerances in the frame and, in particular, in the plate or the aperture. It would also be conceivable for all hooks to be movable relative to each other and/or relative to the frame as part of link elements or indirectly by link elements. For example, two link elements could be moved towards or away from each other simultaneously by a fastening element in the form of a screw with a left-hand thread at one end and a right-hand thread at the other end during screwing.

A very favorable variant of the apparatus according to the invention can provide that the fastening element can be detachably connected to the link element. According to an advantageous design, this can be realized via the screw/thread or threaded rod/thread combination. i.e. in such a way that the fastening element is designed as a screw or comprises a threaded rod which cooperates at least indirectly with a thread of the link element. However, other possibilities are also conceivable here, for example clipping or latching, a connection via a bayonet catch, a connection that can be made and released by turning, for which, unlike a thread, a relatively small angle of rotation of less than 360°, preferably less than 200°, is sufficient, or the like. The elements used for the connection can be supported in their mode of action by a spring or resilient parts of the elements.

Another very favorable variant of the apparatus according to the invention can also provide that the fastening element is designed as a clamping element or has such a clamping element. The fastening element for fastening the cover and for simultaneously moving the link element can thus be a clamping element. Lever clamps, toggle clamps or the like are conceivable here.

In particular, the clamping element can also be combined with a threaded rod so that the latter is screwed into the link element and moves the latter over part of its path transversely to the running direction of the accommodated elongated strands, whereupon the remaining path is covered by the clamping of the clamping element to securely fix the hook of the link element and the cover. Preferably and more particularly thereto, the clamping element may be in the form of an eccentric clamping lever. An alternative to this can also be another type of detachable fastening, e.g. between a rod and the link element or a projection of the link element and the clamping element.

According to an extraordinarily favorable further development of the apparatus according to the invention, it can be provided that the frame, e.g. the lower frame part, has at least one recess for the link element on its rear side facing the plate in the assembled state. According to an extraordinarily favorable further development of the apparatus according to the invention, the link element can be inserted into this recess transversely to the running direction of the inserted elongated strands or clipped in in the running direction of the inserted elongated strands. This structure enables simple assembly, in which the link element can be clipped into the corresponding recess, for example, and is then securely and captively seated in this recess and, in particular, cannot be moved out of the frame in the direction of the rear side without additional force. Via the fastening element, for example in the form of a thread/screw combination, the link element can then be moved in the recess transversely to the running direction of the inserted elongated strands, for example along the longest axis of the respective leg of a part of the frame.

This makes it possible to change the distance to the further hook, which is stationary, for example, in the plane of the plate, so that the frame can be braced via the hooks, for example, in the aperture itself or in holes provided next to the aperture, which have been used in this way in conventional setups to date. In particular, the possibility of also inserting the hooks into these bores and bracing the frame in the bores is advantageous in this respect for retrofitting existing installations with the novel apparatuses, since, in accordance with the following designs, they also enable further advantages apart from simple assembly and disassembly from one side of the plate.

Preferably, according to a very favorable design of the apparatus according to the invention, the link element can be moved via the fastening element which is accessible from a front side facing away from the frame of the plate in the mounted state. Preferably, the link element can have a thread for this purpose, which is accessible from a front side facing away from the frame of the plate in the assembled state and forms part of the thread/screw combination. The required screw or threaded rod, which can in particular also be part of a clamping element, is thus accessible from the front side.

According to an exceptionally favorable design, the central axis of the thread is thereby formed obliquely to the running direction of the inserted strands and obliquely to a central plane of the plate around the aperture. The central axis of the thread and thus the central axis of the screw can thus be arranged obliquely in this particularly favorable design. This makes it exceptionally accessible, for example by means of a cordless screwdriver, even when the frame is mounted on the plate or when the frame is mounted on the plate. Furthermore, this oblique arrangement of the screw enables very simple assembly of the link element in the recess, since the latter slides easily and efficiently transversely to the running direction of the cable in its recess due to the oblique engagement of the screw, thereby reliably bracing the frame in the aperture or the mounting holes of the plate.

An advantageous further development of the apparatus according to the invention can now also provide that the recess for the link element is formed in the respective part of the frame in such a way that the link element moves obliquely to the plane of the plate during its movement transverse to the running direction of the inserted elongated strands. Such a movement obliquely to the plane of the plate, preferably obliquely away from the plate, may thus have some advantages. On the one hand, especially in a combination of the oblique thread and preferably an aligned orientation of the movement on the one hand and the thread on the other hand, friction in the assembly can be minimized. It is also the case that with such an oblique movement, the hook is moved towards the material of the plate on the one hand and in the plane towards the edge of the aperture or hole in the plate on the other hand. Thus, in addition to the direction of movement along the plate, it has another component of movement perpendicular to the plate. This can, in particular if the plate is uncleanly deburred in the edge area or the like, help to improve the fastening of the frame to the plate, because the force component for clamping the frame to the plate does not have to be applied by the hook and its shaping alone, as would be the case with a movement in the plane of the plate, but is supported by an oblique movement of the hook relative to the plate by the additional movement component.

The frame can therefore now be easily and securely fixed in an aperture via the fastening element and the link element. For this purpose, the frame can be fitted with cables and grommets and closed. The frame parts can be clipped or screwed together in the conventional way. The frame is then fastened to the aperture in the manner described by the movement of at least one link element with its hook relative to another hook.

An extraordinarily favorable further development of the apparatus according to the invention can further provide that the fastening element and a receptacle for the fastening element in the frame is designed in such a way that the fastening element cooperating with the link element connects the frame cover to the lower frame part and moves the link element with its hook transversely to the running direction of the inserted elongated strands relative to at least one of the further hooks. With this structure, which can be implemented, for example, with the screw or a clamping element positioned obliquely opposite the plate as the fastening element, it is thus possible to implement both the fastening of the frame to the plate and the fastening of the frame cover to the lower frame part and thus the pressing of the inserted grommets with the elongated strands in a simple manner. For example, two screws or clamping elements, which are arranged in the respective outer legs of the U-shaped lower frame part or the corresponding areas of the frame cover and interact with the link elements in the legs of the lower frame part, can be used both to securely and reliably close the cover and to fasten the frame to the plate. Something similar would also be conceivable, for example, with two L-shaped frame parts, so that the frame cover and the lower frame part are each of the same design and the screws are thus diagonally offset from one another. Two U-shaped frame parts could also be used here.

The fact that the screws are positioned at an angle both to the running direction of the inserted cables and to the surface of the plate or aperture means that they are relatively easy to access in any installation situation. The fastening, e.g. in the form of a screw connection, can be easily tightened or loosened using a cordless screwdriver. When using clamping elements, such as clamping levers, this could even be implemented without tools. This makes it possible to use only two fastening elements for the complete assembly of the frame, including the inserted grommets and strands, and to do this with good accessibility to the fastening elements, which are at an angle to the plate and the running direction of the elongated strands. This not only simplifies assembly, but also allows cables to be easily and efficiently retrofitted, removed from the frame or replaced accordingly, without the need for great effort and without the need for accessibility from both sides of the plate, as is the case with previous setups.

It is particularly advantageous if the frame parts each have a recess for one of the movable link elements in their section facing the other frame part. This can then preferably be movable along the axis of at least one leg of the respective frame part or at an angle thereto. In turn, the sections of the frames facing away from the respective other frame part can have the further, e.g. fixed, hooks. Preferably, both a movable and a fixed hook are arranged on each of the legs. In the case of particularly wide frames, a further fixed hook can be provided, for example, in the center of a base or cover area of one of the frame parts.

According to a very favorable further development of the apparatus according to the invention, the further hooks can be formed by link elements which are inserted in recesses of the frame parts and do not move appreciably transversely to the running direction of the inserted strands. Thus, the quasi stationary hooks can be realized simply and efficiently by the same link elements which are also used to design the movable hooks. Nevertheless, a certain tolerance compensation is possible through minimal movements. This can be correspondingly favorable, for example, in the case of link elements and hooks manufactured by die casting. For example, such elements made of die-cast zinc or die-cast aluminum, which have a relatively higher stability than those made of plastic, can be incorporated into a frame otherwise made of plastic or a fiber-reinforced plastic.

Alternatively, it would of course also be conceivable to form the link elements themselves from plastic, preferably a fiber-reinforced plastic, or to realize them as sheet metal parts by stamping and forming. In general, machining, for example from a metal, would also be conceivable.

As an alternative for the design of the further hooks, it may also be provided that these are formed integrally and stationary with one or the respective frame part, i.e. are realized, for example, as part of this lower frame part. In order to absorb the corresponding forces, the design can be realized in this case with a fiber-reinforced plastic or an insert made of a stronger plastic material, metal or the like, which is inserted in advance when the frame is manufactured by injection molding. Such an insert would also fall under the concept of integral in the sense of the invention, since such an insert is permanently and firmly connected to the frame after manufacture because it is non-detachably injection-molded around by the material of the frame and is thus regarded as integral in the sense of the present description.

In the case of a threaded link element, the slope of the central axis of the thread can preferably be arranged at an angle of about 20 to 60° to the plane of the plate. Such an angle of preferably somewhat less than 450 ensures reliable movement of the link element transverse to the running direction of the cable during screwing. In the particularly preferred variant, in which the frame cover is screwed on with the same screw, an angle of more than 30° can also ensure reliable pressing of the grommets and reliable pressing of the frame cover onto the lower frame part and/or vice versa. This enables a high degree of tightness of the assembly, especially if, and this is also known from the prior art, appropriate sealing elements are arranged between the frame cover and the lower frame part, e.g. injected seals made of an elastomeric material, or even labyrinth seals made of the material from which the cover and the frame are made anyway.

According to an advantageous design of the apparatus according to the invention, the hooks themselves can have engagement surfaces for contact with the plate in the mounted state of the frame, which are oriented obliquely to the plane of the plate. Such engagement surfaces of the hooks extending obliquely to the plane of the plate, wherein an obliquity of, for example, 10 to 20° may be useful here, permits reliable mounting of the frame on plates with a certain thickness variance. For example, the plates, which in the case of machine controls or control cabinets are typically in the form of metal sheets, can have thicknesses in the order of 1.5 to 3 mm, for example. In this case, for example, due to a coating or the like, the thickness is never exact, so that by means of the slope of the engagement surfaces and a correspondingly slightly wider or less wide movement of the same when tightening the screws and moving the link elements, an adaptation to this thickness can be achieved, so that regardless of the exact thickness of the plate, a very reliable and stable fastening of the frame to the plate is possible.

This inclined engagement surface is particularly decisive when the movement of the link element is parallel to the plane of the plate. In the case of a movement of the link element that is oblique to the plane of the plate, this embodiment variant can be helpful, but is not absolutely necessary. Therefore, according to a favorable further development of the apparatus according to the invention, it may also be provided that at least one of the hooks has an engagement surface extending substantially parallel to the plane of the plate. In the case of the oblique movement of the link element, in which the hook in any case undergoes a component of movement on the one hand in the plane of the plate and on the other hand perpendicular to the plane of the plate, this design may also be sufficient. In particular, in the case of small dimensions of the hook, even better fastening can be achieved in this way, since, unlike in the case of an oblique contact surface, the risk of the hook slipping off the material of the plate is minimized.

Typically, seals are also formed between the frame and the plate around the aperture or around the holes to seal the assembly from the environment, Together with the elasticity of this typically inserted seal and the oblique engagement surfaces and/or the obliquely moved hooks, this creates an assembly which can respond easily and efficiently to different plate thicknesses and plate surface conditions, so that the apparatus can be securely and reliably mounted to the plate and reliably secured and sealed from it in almost all cases encountered in practice.

In this case, the frame part can have two legs and at least one intermediate web between the two outer legs, as is known in principle from the prior art, so that at least two or more chambers are created to accommodate the grommets. This structure would also be conceivable in an analogous way for a frame with two L-shaped frame parts, in which case each of the frame parts has one of the legs and at least one intermediate web. In both variants, the intermediate webs could also be implemented half in each of the respective frame parts and would then complement each other to form the complete intermediate web when mounted centrally in the frame.

This structure with intermediate webs, known in principle from the prior art, can also be implemented accordingly in the frame of the apparatus. In accordance with a very favorable further development of this idea, it can be provided that one of the frame parts, in particular the frame cover, is screwed in the region of the at least one intermediate web or at least one of the intermediate webs to the respective other frame part, in particular the lower frame part. This can be carried out either by means of a link element with or without a hook or by means of a thread introduced directly into the intermediate web, either in the material of the intermediate web or in a threaded sleeve introduced into the intermediate web. Preferably, this additional screw is also at an angle both to the running direction of the inserted elongated strands and to the plane of the plate, preferably at approximately the same angle as the screws for actuating the link elements and in particular also for fastening the frame parts to one another, i.e. for closing the frame.

Further advantageous designs of the apparatus according to the invention also result from the exemplary embodiments, which are described in more detail below with reference to the figures.

The drawings show as follows:

FIG. 1 shows a three-dimensional view of an embodiment of the apparatus according to the invention mounted on a plate with inserted grommets and sections of cables;

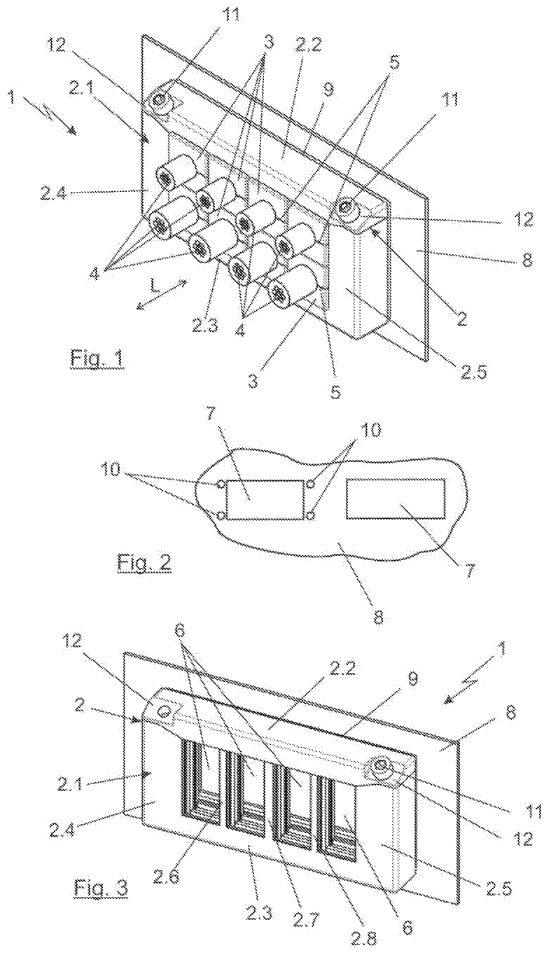

FIG. 2 shows two possible variants for the design of the aperture in the plate;

FIG. 3 shows a three-dimensional view analogous to the illustration in FIG. 1 without cables and grommets and without one of the screws;

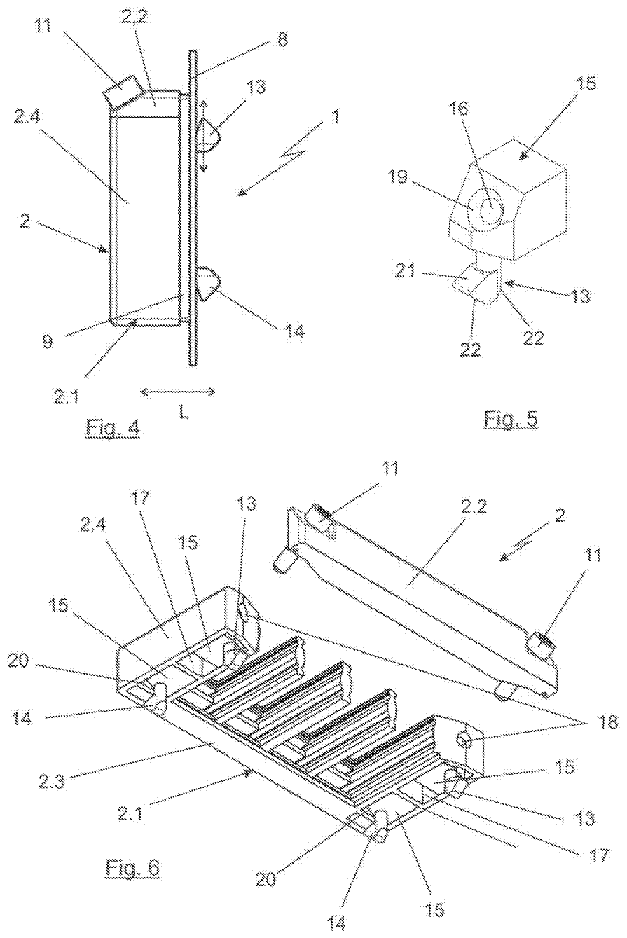

FIG. 4 shows a side view of the three-dimensional representation in FIG. 3;

FIG. 5 shows a three-dimensional view of an exemplary link element;

FIG. 6 shows a three-dimensional view of the frame and frame cover prior to assembly as seen from the rear of the frame;

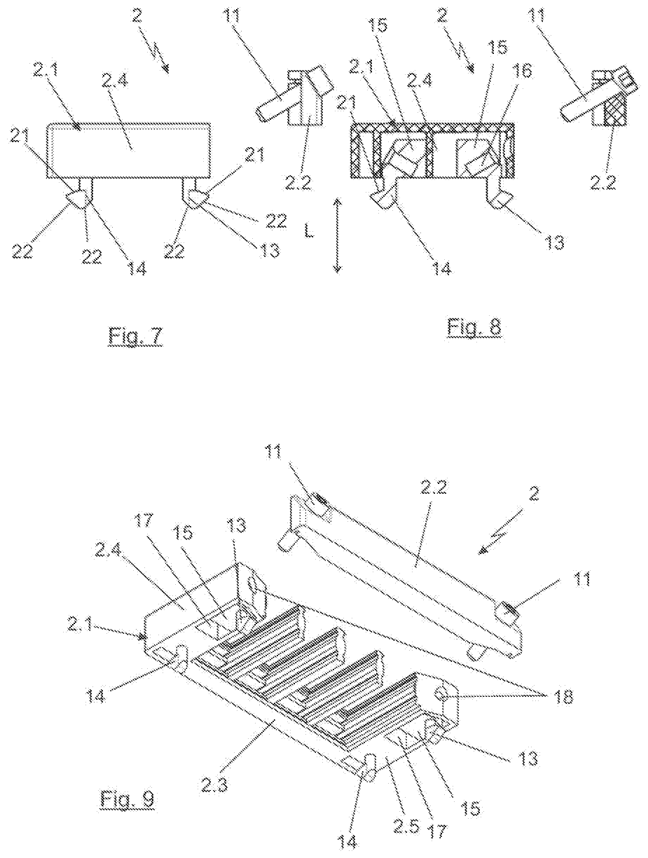

FIG. 7 shows a side view of the representation in FIG. 6;

FIG. 8 shows a side view of the representation in FIG. 6 analogous to that in FIG. 7, but in section;

FIG. 9 shows an alternative design of the frame in a view analogous to that in FIG. 6;

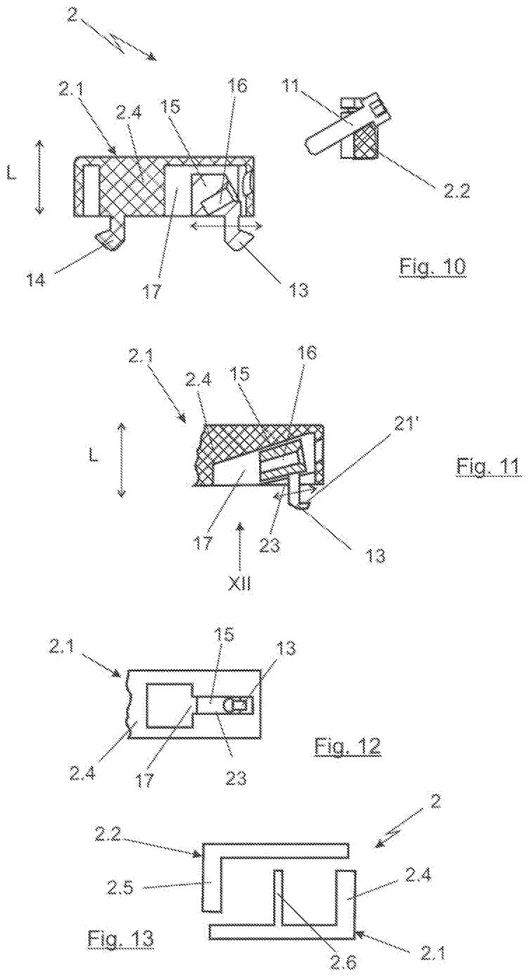

FIG. 10 shows a sectional view of the alternative structure of the frame analogous to that shown in FIG. 8;

FIG. 11 shows a sectional view of the lower frame part of a further alternative structure;

FIG. 12 shows the leg of the frame from the illustration in FIG. 11 in a view from below;

FIG. 13 shows an alternative possible structure of the basic shape of the frame;

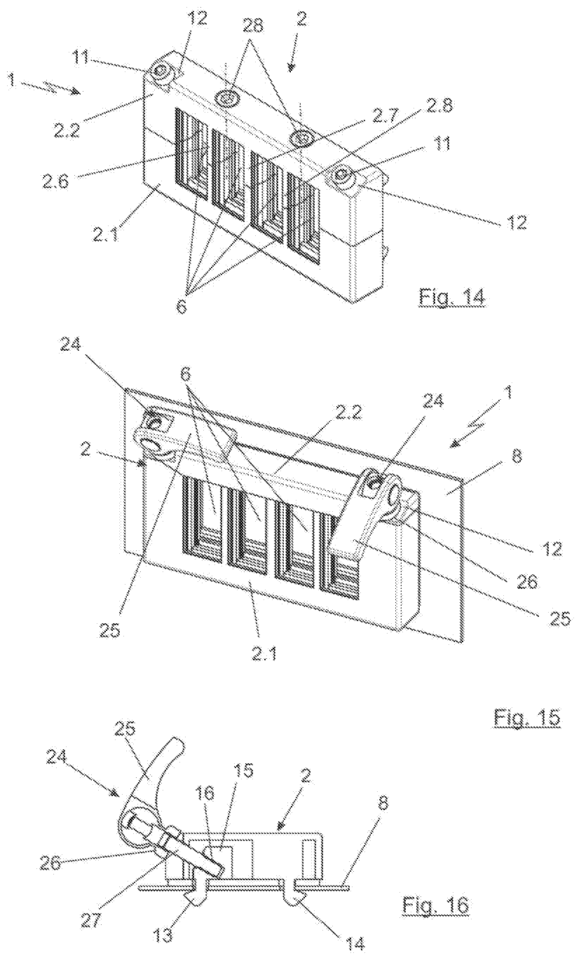

FIG. 14 shows another alternative possible construction of the basic shape of the frame analogous to the illustration in FIG. 3;

FIG. 15 shows a frame analogous to the illustration in FIG. 3 with alternative fastening elements; and

FIG. 16 shows a schematic sectional view of the frame from FIG. 15.

In the illustration of FIG. 1, a three-dimensional view of the apparatus 1 can be seen. It consists substantially of a frame 2 in which a number of grommets 3 are accommodated. The eight grommets in the exemplary embodiment shown here are made of elastic material and each have a central aperture through which an elongated strand 4 can be inserted. The elongated strands 4 are indicated here as cables in sections. The apparatus 1 could just as well be used for the passage of hoses or the like. Different apertures can also be made in the grommets 3 for different types of cables, so that the round cross-sectional shape of the cables shown here is to be understood purely as an example. Each of the grommets 3 has a slot 5 at the side, which connects the aperture in the center of the grommet 3 to the outer edge. The grommet 3 can thus be unfolded so that longer cables can also be inserted without having to thread the grommet over the cable. In particular, pre-assembled cables with connectors or corresponding hoses, for example with welded-on hose terminating elements or the like, can also be inserted in this way. In a manner known per se, these grommets are then inserted into chambers 6 of the frame 2, which can be seen in FIG. 3, and are held positively in the frame 2. The running direction L of the strands 4 is essentially perpendicular to the extension or plane of the plate 8.

The frame 2 consists of a lower frame part 2.1 and a frame cover 2.2. Here, the lower frame part is substantially U-shaped and has a base part 2.3 and two lateral outer legs 2.4, 2.5. The base 2.3, together with the legs 2.4 and 2.5, forms the U-shaped basic structure of the frame 2. As can be seen in the illustration in FIG. 3, there are also optional intermediate webs in between, in the example shown here three intermediate webs 2.6, 2.7 and 2.8, which in total form four chambers 6 for accommodating the grommets 3, with two grommets lying one above the other in each chamber 6. When the cover 2.2 is fastened to the lower frame part 2.1, these grommets 3 are pressed together in a manner known per se so that, on the one hand, a sealed structure is created and, on the other hand, the contact of the cables with the elastic material of the grommets 3 provides strain relief for the strands 4, in this case e.g. the cables.

Alternatively to the illustration, it would also be conceivable to design the frame cover 2.2 and the lower frame part 2.1 in each case analogously to one another, so that both would thus be essentially U-shaped. The combination of two essentially L-shaped parts 2.1, 2.2 would also be conceivable, in which case in each case one of the legs 2.4 would be in one part 2.1 and one of the legs 2.5 would be in the other part 2.2 of the frame 2. Such a structure of the frame 2 with an optional intermediate web 2.6 is indicated in principle in FIG. 13.

This frame 2 with the grommets 3 is then fitted around an aperture 7 in a plate 8, this aperture 7 being indicated in two different ways in the illustration of FIG. 2 as an example. A sealing element 9 is also arranged between the plate 8 and the frame 2 in order to seal the structure appropriately, so that the aperture 7 is sealed appropriately tightly by the fitted frame 2 and the chambers 6 sealed in the frame 2 via the grommets 3 and the inserted cables.

Instead of the grommets 3 shown here, grommets 3 in other sizes are also conceivable. For example, if the intermediate web 2.8 is omitted, a grommet the size of four individual grommets could be introduced here. This may, for example, have a larger opening for a thick cable, a thick pipe or the like, or may have several openings within a single grommet. Again, these openings are preferably each individually connected to the edge of the grommet 3 via a slot 5 accordingly. This is so far known from the prior art and can be used here analogously to this prior art. To increase the flexibility of the structure, grommets 3 without a hole and slot 5 can also be used. Such dummy grommets or also conventional grommets, which have been provided with a dummy plug instead of the cable, then merely seal the structure without an elongated strand 4 being passed through them. This means that, for example, a smaller number of five cables or the like could be inserted with the structure shown here, and up to three additional cables could be retrofitted if required.

The plate 8 is typically a sheet metal plate, which represents the wall of a machine control or a control cabinet or the like. It is typically a few millimeters thick and the frame 2 is attached to it as already described above. In prior art structures, a central aperture 7 for the cables, as can be seen in the illustration of FIG. 2 on the left, is known in this connection. In addition, there are typically four holes 10 distributed around the aperture 7, through which the frame 2 in the prior art design is appropriately fastened with bolts and nuts arranged on the other side of the plate 8. This structure of the aperture 7 with the holes 10, as shown in the illustration of FIG. 2 on the left, can also be used for the apparatus 1 according to the invention. Likewise, the somewhat larger aperture 7 shown on the plate 8 on the right in the illustration of FIG. 2 can be used accordingly without the holes 10.

The special feature of the structure now lies in the fact that both the fastening of the cover 2.2 to the lower frame part 2.1 and the fastening of the frame 2 in the aperture 7 or the holes 10 can be achieved by only two screws 11 as fastening elements. With the tightening of these screws 11, which are arranged, for example, at an angle of about 40° obliquely to the plane of the plate 8, both the fastening of the frame 2 to the plate 8 can then be effected in the manner described in more detail later, and the cover 2.2 can be firmly connected to the lower frame part 2.1. The forces required for this only slightly exceed those required for the conventional design, since the force for pressing the cover and the force for fastening it to the plate 8 are vectorially added by the inclined position of the screws 11, so that the resulting force in the direction of the screws 11 is smaller than the sum of the forces required so far.

The illustration in FIG. 3 shows that the two screws 11, of which only one is shown here, interact with the cover 2.2 via a slope 12 so that the cover 2.2 is pressed accordingly. The cover 2.2 itself is thereby fixed by the screws 11, which on the one hand fix the cover 2.2 upwards and forwards relative to the lower frame part via their slope 12, while it is held correspondingly at the rear by corresponding positive-locking elements between the cover 2.2, and the lower frame part 2.1 or by the presence of the plate 8 during the assembly of the frame 2.

In the illustration of FIG. 4, the entire structure can be seen again in a side view in the assembled state. In this side view, two hooks 13, 14 can be seen protruding through the aperture 7 not visible here or the holes 10 in the plate 8, which enable the frame 2 to be fastened relative to the plate 8.

These hooks 13, 14 are designed in such a way that at least one of the hooks, here the hook 13 as indicated by the double arrow, can move along the plane of the plate 8, i.e. transversely to the running direction of the inserted strands 4. This movement is achieved by the fact that the hook 13 is part of a link element 15 shown in FIG. 5, which, in addition to the hook 13, also has a thread designated 16 for accommodating the screw 11.

The detailed arrangement of this structure can be seen better in the view from the rear of frame 2 in FIG. 6. The cover 2.2 of the frame 2 is shown here in the not yet assembled state. Two link elements 15 are located in two recesses 17 of the two legs 2.4 and 2.5 of the lower frame part 2.1. The link elements 15 with the movable hooks 13 are seated in the recesses 17, which are designed in such a way that the link elements 15 can be clipped in, for example from the rear side of the frame 2, but are then captively seated in the recesses 17 after clipping in and, in particular, can no longer be pressed out of them in the direction of the rear side. The recesses 17 are also so large that the link elements 15 are movable along the longest axis of the legs 2.4 and 2.5 in order to be able to realize the movement of the movable hook 13 already shown in FIG. 4.

Through openings 18, the screws 11 inserted at an angle in the cover 2.2 of the frame 2 now reach the area of the link elements and can be screwed into the threads 16. To make it easier to find the correct position, a funnel-shaped guide 19 is located in front of the thread 16 in the link element 15, as shown in FIG. 5. With the tightening of the screws 11, on the one hand the cover 2.2 is then pressed onto the lower frame part 2.1 and on the other hand the link element 15 in the respective leg 2.4, 2.5 is pulled in the direction of the cover 2.2 and thus in the direction of the edge of the aperture 7 or the holes 10. The further hooks 14 are arranged here, for example, in a stationary manner with respect to the lower frame part 2.1, so that, as a result of the movement of the movable hooks 13, these fix the frame 2 to the plate 8 accordingly when the screws 11 are tightened. The general mobility of the link element 15 in the recess 17 also permits tolerance compensation.

In the illustration of FIG. 6, it can be seen that the further hooks 14 arranged here in a fixed position relative to the frame 2 are also formed by the link elements 15 in the design described above. However, these link elements 15 with the hooks 14 are arranged in matching free spaces 20 of the legs 2.4 and 2.5 of the frame 2, in which they are not movable or are only minimally movable in the direction parallel to the plane of the plate 8, so that they can only effect tolerance compensation but do not yield when the screws 11 are tightened and the clamping movement applied by the hooks 13 of the movable link elements 15. The structure is thus securely clamped in the holes 10 or the aperture 7 itself.

In the illustrations in FIGS. 7 and 8, the structure shown in FIG. 6 can be seen again in a side view and in a sectional view through one of the legs 2.4. The hooks 13 and also the hooks 14 have an engagement surface 21, which are thus provided with a reference sign in FIGS. 5 and 7. This engagement surface 21 with an inclination of about 10 to 20° with respect to the plane of the plate 8 has the effect of compensating for different material thicknesses of the plate 8, and that the frame 2 can be reliably fixed to plates 8 of different thicknesses. In addition to this engagement surface 21, the hooks 13, 14 also have an insertion slope 22, so that they can be inserted more easily into bores 10, in particular during assembly, because the movable link element 15, in particular, is correspondingly optionally displaced in the recess 17 during insertion as a result of the insertion slope 22 in order to simplify assembly. After the hooks 13, 14 have been positioned in the aperture 7 or the bores 10, they are moved away from each other again by the tightening of the screws 11 due to a movement of the movable link elements 15 in the recesses 17 and thus brace themselves with the plate 8, wherein on the one hand the frame 2 is pulled in the direction of the plate 8 due to the inclined engagement surface 21 and on the other hand different material thicknesses of the plate 8 can be compensated.

The link elements 15 with the movable hooks 13 in the illustrations of FIGS. 6 and 8 are shown largely in their end positions in the assembled state. In the position shown here prior to actual assembly, these would in practice lie further down in the recess 17 in FIG. 6 and further to the left in FIG. 8 and would only be braced into the corresponding position by tightening the screw 11, whereby on the one hand the frame 2 is reliably fastened to the plate 8 and the frame cover 2.2 is reliably fastened to the lower frame part 2.1 and the grommets 3, which are not shown here, are pressed into the frame 2 with the inserted strands 4.

The design as shown in FIGS. 6 to 8 has the advantage that the same components can be used for both the movable hooks 13 and the further hooks 14 by using link elements 15. If the frame 2 is made of plastic, for example, then, depending on the plastic material, the stability for the link elements 15 and the hooks 13, 14 may not be sufficient, so that link elements 15 made of die casting, for example, zinc or aluminum die casting, can be used, for example. Likewise, for example, the use of a sheet metal element or a plastic part provided with a corresponding reinforcement, for example a fiber reinforcement, would be conceivable in principle.

In an alternative design, the further hooks 14 can also be connected directly to the lower frame part 2.1 in a non-movable and stationary manner or be formed integrally therewith. This embodiment variant is shown again in the illustration of FIGS. 9 and 10, analogously to the illustration in FIGS. 6 and 8. The hooks 14, which are here arranged stationary relative to the frame 2, are formed directly from the material of the legs 2.4 and 2.5. The movable hooks 13 are again formed in the link elements 15 and act in the manner described above. It would also be conceivable to screw the further hooks 14—not shown—into the legs 2.4 and 2.5 of the frame 2 in the running direction L of the strands 4, in particular with a screw accessible from the front of the frame 2, in order to be able to retighten the further hooks 14 in the running direction L of the inserted strands 2 if necessary.

Due to the angled arrangement of the screws 11, they are always easily accessible. Both the closing of the frame 2 and its mounting on or in the aperture 7 or the holes 10 and thus on the plate 8 can be realized by tightening only these two screws 11. Due to the inclined position, the screws 11 can thereby be tightened easily and efficiently even with larger tools, such as a cordless screwdriver, which was relatively difficult with the screws previously used for closing the frame 2, which ran parallel to the plane of the plate 8. This makes the assembly correspondingly easier, not only in the initial assembly. The assembly of the device can also be disassembled much more easily, or the cover 2.2 of the frame 2 can be opened, so that, for example, a new cable 4 can be inserted quickly and efficiently, an existing cable 4 can be replaced or the like.

Another possible variant, which could also be realized in this way with all previous variants, can be seen in the illustration of FIG. 11. The structure again essentially shows a part of the leg 2.4 of the lower frame part 2.1. In this case, however, the recess 17 is formed obliquely, preferably at approximately the same angle obliquely relative to the plane of the plate at which the thread 16 is also obliquely positioned. This angle can be, for example, 20 to 60°, preferably 30 to 45° with respect to the plane of the plate. The link element 15 is thus moved by the screw 11, not shown here, in the thread 16, as represented by the double arrow, together with its hook 13, obliquely with respect to the plane of the plate and transversely to the running direction L of the inserted elongated strands. In practice, this has the effect of reducing the friction between the link element 15 and the material surrounding the recess 17.

In addition, due to the oblique movement of the link element 15 and thus in particular of the hook 13, a movement component of the hook 13 can be achieved both in the plane of the plate 8 and perpendicularly thereto. Through this, even in the case of a sharp-edged opening in the plate 8, the fastening of the frame 2 is facilitated accordingly, since the hook 13 now no longer generates a force component in the running direction L of the subsequently inserted elongated strands 4 exclusively through the inclination of its engagement surface 21, but also through a movement component extending perpendicularly to the plane of the plate 8, which movement component originates from the inclined movement of the link element 15. For this reason, and as is indicated in the representation of FIG. 11, the oblique engagement surface 21 can be dispensed with. Here, the engagement surface is formed parallel to the plane of the plate 8 and is therefore designated with reference sign 21′ for distinction.

The recess 17 can, as can be seen in the illustration of FIG. 12 of a view of the leg 2.4 of the lower frame part 2.1, be designed in such a way that in its region shown on the left in FIG. 12 the recess is so large that the link element 15 can be inserted. It can then be moved accordingly on an inclined plane, which has only a slot designated 23, through which the hook 13 projects and can be moved along the slot 23 transversely to the running direction L of the inserted strands 4, and thereby at an angle of here, for example, about 30° to the plane of the plate 8. As an alternative to the varied engagement surface 21′, the oblique engagement surface 21 as shown in the previously described figures would of course also be conceivable here, in order to achieve a further force component in the running direction L of the inserted strands 4, in addition to the movement component of the link element 15 and the hook 13, also by means of the oblique engagement surface 21.

In the illustration of FIG. 14, an alternative structure of the frame 2 can now be seen, analogous to the illustration in FIG. 3, but without the plate 8 being shown again. The cover 2.2 of the frame 2 and the lower frame part 2.1 are here realized with a respective part of equal size, which forms the chambers 6 for receiving the grommets 3 not shown here. The frame 2 is thus divided here approximately centrally into two U-shaped frame parts. Other alternatives, such as a frame 2 with the frame cover 2.2, the lower frame part 2.1 and an intermediate frame part in between, from which chambers 6 open both in the direction of the frame cover 2.2 and in the direction of the lower frame part 2.1, would also be conceivable in principle. Such a structure is shown, for example, in FIG. 9 of EP 1 236 256 B1 mentioned at the beginning. This could be transferred accordingly with regard to the division of the frame 2.

The illustration in FIG. 14 also shows a design which is also conceivable in all the exemplary embodiments already explained and still shown. The frame 2 is fastened here via the screws 11, the link elements 15 and hooks 13, 14 in the aperture 7 of the plate 8. The two frame parts 2.1 and 2.2 are connected thereto via an indicated screw connection 28. For this purpose, two screws are arranged in the area of two of the intermediate webs 2.6, 2.8. Instead of such a screw connection 28, however, it would also be possible to clip the frame parts 2.1 and 2.2 to each other, to brace them by means of a clamping lever or a turnbuckle or the like. The closed frame 2 provided with cables 4 and grommets 3 is then fixed in the opening 7 of the plate 8 via the screws 11 and the hooks 13, 12.

A further alternative of the apparatus 1, again in a representation analogous to that in FIG. 3, is shown in FIG. 15. The structure there corresponds largely to the structure shown in FIG. 3, so that the parts designated and described there are not described again, but are merely provided with the same reference sign. The difference is that instead of the two screws 11, clamping elements 24 are used as fastening elements. These clamping elements 24 are specifically designed as eccentric clamping levers in the exemplary embodiment shown here in FIGS. 15 and 16. The clamping element 24 thus consists of the actual eccentric lever 25, a clamping element 26, which can be moved towards or away from the eccentric lever 25 by means of the eccentric lever 25, and a rod 27, which can be seen in FIG. 16. This rod 27 can, for example, be designed as a threaded rod and is then screwed into the thread 16 of the link element 15. If the eccentric lever 25 of the clamping element 24 is in its relaxed position, then the link element 15 can already be moved a certain distance by screwing in the threaded rod 27, for example in order to roughly secure the structure in the opening 7 of the plate 8 so that it cannot fall out. When the eccentric lever 25 is moved into its clamped position, the clamping element 26 is then pressed in the direction of the slope 12 or moved relative to the rod 27. This moves the link element 15 a further distance transverse to the running direction L of the inserted strands 4. In this way, the frame cover 2.2 is braced against the lower frame part 2.1 and at the same time the entire frame 2 is permanently fixed in the opening 7 of the plate 8 via the hooks 13, 14.

Alternatively to the design as a threaded rod, the rod 27 can also be detachably connected to the link element in another way. For this purpose, for example, a small hook at the end of the rod 27 would be conceivable, which can hook onto the link element 15 after the rod 27 is inserted through a hole in the link element 15. A connection by clipping, latching, by means of a bayonet lock, a twist lock or the like are also conceivable. It is understood that the rod 27 could also be a part of the link element 15 or be realized integrally with it and accordingly be detachably connected to the eccentric lever 25.

In addition to the clamping element 24 in the form of a clamping element 24 with rod 27 and eccentric lever 25, which enables the apparatus 1 to be operated without tools, other clamping elements 24 would also be conceivable, which could be operated with or without tools, for example lever clamps, toggle clamps, turnbuckles or the like.

1-23. (canceled)

24: An apparatus for feeding elongated strands through an aperture in a plate, comprising a divided frame, which comprises a lower frame part and a frame cover which are divided transversely to the running direction of the elongated strands to be inserted, and which has at least one chamber for the insertion of at least one elastic grommet, wherein the frame has devices for fastening the frame to the plate;
wherein the devices comprise hooks for fastening the frame in the aperture of the plate or in fastening holes in the plate, wherein at least two hooks are provided which are designed to be movable relative to one another, wherein at least one of the hooks is designed as part of or movable indirectly by a link element which is movable relative to the frame via a fastening element transversely to the running direction of the accommodated elongated strands.

25: The apparatus according to claim 24, wherein the fastening element can be detachably connected to the link element.

26: The apparatus according to claim 24, wherein the fastening element is designed as a screw or comprises a threaded rod, which cooperate at least indirectly with a thread of the link element.

27: The apparatus according to claim 24, wherein the fastening element is designed as or comprises a clamping element.

28: The apparatus according to claim 27, wherein the clamping element is designed as an eccentric clamping lever.

29: The apparatus according to claim 24, wherein the lower frame part has at least one recess for the link element on its rear side facing the plate in the assembled state.

30: The apparatus according to claim 24, wherein the link element is movable via the fastening element, which is accessible from a front side facing away from the plate in the mounted state of the frame.

31: The apparatus according to claim 26, wherein a central axis of the thread is formed obliquely to the running direction of the inserted elongated strands and obliquely to a plane of the plate around whose aperture the frame is arranged.

32: The apparatus according to claim 29, wherein the recess for the link element is formed in the frame in such a way that the link element moves obliquely to the plane of the plate during its movement transversely to the running direction of the inserted strands.

33: The apparatus according to claim 24, wherein the fastening element and a receptacle for the fastening element are formed in the frame in such a way that the fastening element cooperating with the link element connects the frame cover to the lower frame part and moves the link element with its movable hook transversely to the running direction of the inserted elongated strands relative to at least one of the hooks not cooperating with or formed as part of the link element.

34: The apparatus according to claim 24, wherein the lower frame part and/or the frame cover has at least one leg, wherein the at least one leg has, on its section facing the respective other part of the frame, in each case one recess for in each case one of the link elements.

35: The apparatus according to claim 34, wherein the sections of the at least one leg and/or of the frame facing away from the respective other part of the frame have the hooks not cooperating with or formed as part of the link element.

36: The apparatus according to claim 35, wherein the hooks which do not cooperate with the link element or are formed as part thereof are formed by further link elements which are introduced in a stationary manner in free spaces of the frame with respect to a movement transversely to the running direction of the inserted strands.

37: The apparatus according to claim 35, wherein the hooks not cooperating with or formed as part of the link element are formed as stationary hooks integral with the frame.

38: The apparatus according to claim 24, wherein the link elements are inserted into the recesses of the frame transversely to the running direction of the inserted strands or are clipped in in the running direction of the inserted strands.

39: The apparatus according to claim 26, wherein a central axis of the thread is arranged at an angle of 20 to 60° to the plane of the plate.

40: The apparatus according to claim 24, wherein at least one of the hooks has an engagement surface for engagement with an edge of the plate around the aperture or the fastening hole in the assembled state of the frame, which are oriented obliquely to the plane of the plate.

41: The apparatus according to claim 24, wherein at least one of the hooks has an engagement surface extending substantially parallel to the plane of the plate.

42: The apparatus according to claim 24, wherein the link element is formed from a fiber-reinforced plastic or from a metallic material.

43: The apparatus according to claim 42, wherein the link element is made of zinc die casting.

44: The apparatus according to claim 24, wherein the frame has two legs and at least one intermediate web located between the legs, so that at least two chambers for accommodating grommets are formed in the frame.

45: The apparatus according to claim 24, wherein the one part of the frame can be screwed to the other part of the frame in the region of the at least one intermediate web, in particular via a link element with or without a hook.

46: The apparatus according to claim 24, wherein the frame consists of two frame parts, wherein these frame parts are both substantially L-shaped, are both substantially U-shaped frame parts or are designed substantially as U-shaped lower frame part and as a straight frame cover.
